(19) United States
(12) Patent Application Publication
(10) Pub. No.: US 2005/0242656 A1
(43) Pub. Date: Nov. 3, 2005

(54) Plated covers for vehicle wheel assemblies

(76) Inventor: Scott A. Hogan, Sylvan Lake, MI (US)

Correspondence Address: Michael S. Gzybowski;BUTZEL LONG, Suite 300, 350 South Main Street, Ann Arbor, MI, 48104, US

(21) Appl. No.: 10/836,038

(22) Filed: Apr. 30, 2004

(51) Int. Cl. B60B 7/14

(52) U.S. Cl. 301/37.101

(57) ABSTRACT

A method of fabricating decorative wheel covers which involves forming decorative wheel covers that have sharp edges such as edges along brake vent windows or openings. The shape edges are dulled by subjecting the wheel covers to a plating process that plates both sides of the wheel covers. The plating process rounds off or dulls the shape edges of the wheel covers. The ability to dull the sharp edges of the wheel covers allows for the design and fabrication of metal wheel covers having profiles that push the limits on the formability of metals such as stainless steel. The plating method also dulls sharp edges on plastic wheel covers.

### TECHNICAL FIELD

The present invention relates to vehicle wheel assemblies that include decorative wheel covers which are secured to underlying wheels. More specifically, the present invention relates to methods for producing decorative wheel covers that have formed edges and particularly to methods for reducing the sharpness of the formed edges.

### BACKGROUND ART

Wheel assemblies that utilize wheel appliques to decorate the external or outboard surfaces of plain steel wheels are well known and are far less expensive to produce than one-piece decorative wheels that have to be formed and finished. Wheel appliqués or covers can be secured to the outboard surfaces of wheels by a variety of adhesive materials that are applied as continuous layers or discrete patterns between the inboard surface of the wheel covers and the outboard surface of the wheels. Alternatively, or in addition to the use of adhesive materials, various mechanical means including clips, fasteners, biased engaging structures, etc. can be used to secure wheel covers to wheels.

Decorative wheel covers are typically made from metal stock or molded from plastic materials. In all cases the wheel covers have finished outboard surfaces that may be painted, textured or plated, e.g. chrome plated, as desired. The use of plastic materials has gained popularity recently because plastics are easy to mold into complex profiles associated with decorative wheels that include various configurations and combinations of spokes or spiders and openings or windows that are decorative and/or functional.

Notwithstanding the ease of manufacturing and lower material cost associated with plastic decorative wheel covers, there are preferences to using metal wheel covers including the fact that in some applications metal wheel covers can feel and sound more solid than plastic wheel covers after being assembled to a wheel. In particular, metal wheel covers that are attached to wheels tend to have a metallic sound when tapped or struck whereas plastic wheel covers tend to have a dull or muted sound in similar circumstances. The impression which is not necessarily justified is that wheel assemblies having metallic wheel covers are metal and solid whereas wheel covers having plastic wheel covers are laminated articles which are not as solid.

Metal wheels are generally not cast or injection molded. Rather they are formed using metal fabrication techniques such as stamping, punching, cutting, pressing, bending, drawing, etc. Unlike plastic materials that can be molded, there are physical limitations imposed on the ability of metals to be fabricated into certain shapes. For example, if a wheel cover design has a profile height that is extreme or if the design includes a profile that has complex bends, it might be physically impossible to work a stock sheet of metal to conform to such a design profile.

Because of such concerns, designers have found it necessary to limit the complexity of designs for decorative wheel that are to be made from metals.

The present invention involves wheel cover designs that push the limits on the formability of metals used to fabricate wheel covers. The present invention moreover addresses and solves problems that arise from such advanced designs.

### DISCLOSURE OF THE INVENTION

According to various features, characteristics and embodiments of the present invention which will become apparent as the description thereof proceeds, the present invention provides a method of forming a decorative wheel cover that is configured to be attached to a vehicle wheel which method involves:
forming a wheel cover in a manner that produces at least one sharp free edge along a portion of the wheel cover, the wheel cover including an outboard side and an inboard side; and
subjecting the formed wheel cover to a plating process which plates both the outboard side and inboard side of the wheel cover and dulls the at least one shape free edge.

The present invention further provides for a decorative wheel cover that includes:
a wheel cover having inboard side, an outboard side which is configured to be attached to a vehicle wheel; and
a metallic plating layer on each of the inboard and outboard sides of the wheel cover.

The present invention further provides a wheel assembly that includes:
a wheel having an outboard side; and
a wheel cover attached to the outboard side of the wheel, said wheel cover having inboard side, an outboard side, the inboard and outboard sides of the wheel cover being plated with a metallic material.

The present invention also provides for a method of dulling sharp edges formed on a decorative wheel cover which involves:
forming a wheel cover in a manner that produces at least one sharp free edge along a portion of the wheel cover, the wheel cover including an outboard side and an inboard side; and
subjecting the formed wheel cover to a plating process which plates both the outboard side and inboard side of the wheel cover and dulls the at least one shape free edge.

In general, the present invention provides for decorative wheel covers that are plated in such a manner to dull any sharp edges that are produced during the formation of the wheel covers.

### BRIEF DESCRIPTION OF DRAWINGS

The present invention will be described with reference to the attached drawings which are given as non-limiting examples only, in which:

FIG. 1 is a perspective view of a wheel assembly according to one embodiment of the present invention.

FIG. 2 is an exploded perspective view of the wheel assembly of FIG. 1.

FIG. 3 is a perspective view of a wheel cover design according to one embodiment of the present invention.

FIG. 4 is a 135× magnified metallograph photo of a cross-sectional portion of a metal wheel cover that has not been plated.

FIG. 5 is a 135× magnified metallograph photo of a cross-sectional portion of a metal wheel cover that has been plated on one side according to a conventional practice.

FIG. 6 is a 135× magnified metallograph photo of a cross-sectional portion of a metal wheel cover that has been plated on both sides according to one embodiment of the present invention.

### BEST MODE FOR CARRYING OUT THE INVENTION

The present invention relates to methods for producing decorative wheel covers that have formed edges and particularly to methods for reducing the sharpness of the formed edges. In use, the wheel covers are attached to the outboard side of a wheel to produce a wheel assembly with a decorative finish. The present invention allows wheel cover designers and manufacturers to push the limits on the formability of metals used to fabricate wheel covers. Moreover, the present invention addresses and solves problems that arise from such advanced designs.

During the course of the present invention, the inventor experimented with the limits to which stock metals could be formed into decorative metal wheel covers. In particular, metal wheel covers were fabricated using conventional metal forming processes into designs having profile features which required the metal to be worked to theoretical limits. As the extremes of the design profile features increased, e.g., as the height and/or shape configuration between reference points increased requiring the metal to be worked further, portions of the metal became thinner. In the case where the metal became thinner at free edges such as the edges of openings or windows, sharp edges developed which required further processing to dull the shape edges.

Accordingly, the present inventor has discovered that although it is possible to work metal stock during fabrication of more complex or extreme decorative wheel cover designs, an issue arises as to how to treat any sharp edges that are formed on the metal wheel covers.

It is common practice to plate the outboard side of metal (and plastic) wheel covers to produce a desired finish. A common plating material is nickel-chrome which provides the outboard side of a wheel cover with a chrome finish. The present inventor has learned that when metal wheel covers are plated on their outboard surfaces with a material such as nickel-chrome, the plating material builds up on trimmed edges of the wheel covers.

When, according to the present invention, stock metal is worked to fabricate more complex or extreme decorative wheel cover designs, the present inventor has determined that subsequent plating of the outboard side of the wheel covers is ineffective to sufficiently dull sharp edges of the wheel cover. Moreover, the present inventor has further determined that increasing the thickness of the platting on the outboard surface of the wheel covers alone does not dull sharp edges of the wheel cover sufficiently.

According to the present invention, the inventor has discovered that plating both the outboard and inboard sides of the wheel covers effectively dulls any sharp edge created when metal wheel covers are formed.

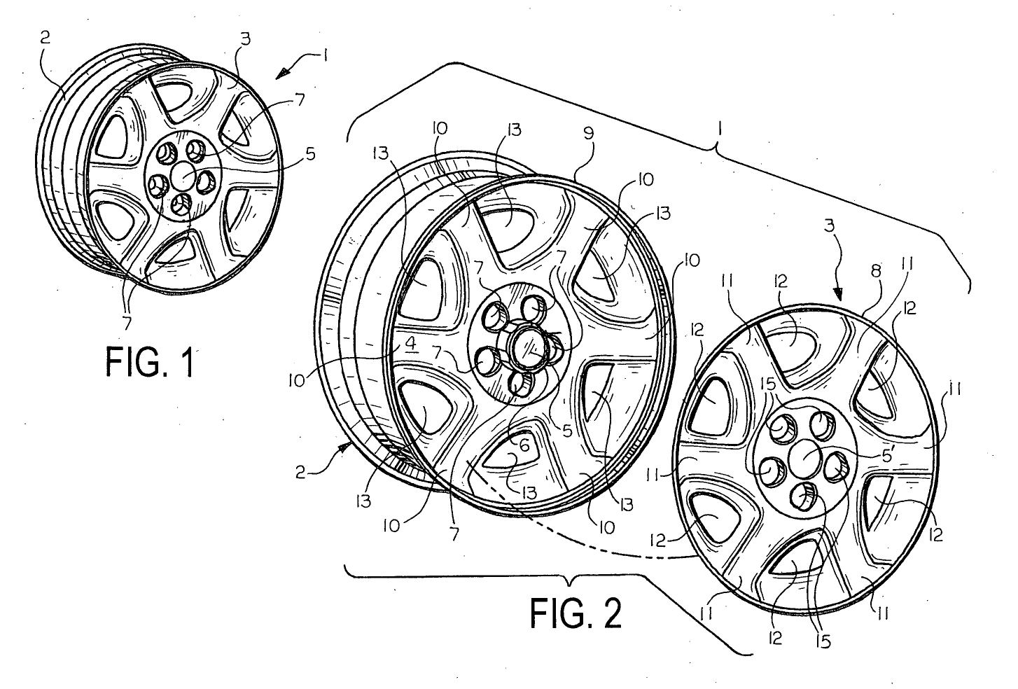

FIG. 1 is a perspective view of a wheel assembly according to one embodiment of the present invention. The wheel assembly which is generally identified by reference numeral 1 includes a wheel 2 that can be made of aluminum, magnesium, steel, or other material conventionally used for manufacturing vehicle wheels. A decorative wheel cover 3 is bonded to the otherwise outer exposed surface 4 (See FIG. 2) of wheel 2. The wheel cover 3 is a thin metallic panel that can be made from stainless steel or other suitable metal or alloy. According to the present invention both the outboard and inboard surfaces of the wheel cover 3 are plated with plating materials that provide a finish that is desired for the outboard surface and dull free edges of the wheel cover 3. Conventional plating materials can be used such as an undercoating of nickel and a surface or finish coating of chrome. The plating of the outboard and inboard sides is accomplished simultaneously for production efficiency (single plating baths/steps can be used for each plating material). However, it is within the scope of the present invention to separately plate either side of the wheel covers using separate plating steps (and racking techniques) or to plate both sides simultaneously with an underlying coat followed by separately plating the outboard and inboard sides with a finish or surface coat. According to one embodiment of the present invention the outboard and inboard sides of wheel covers can be plated with an underlying coat such as nickel and only the outboard side can be plated with a finish coat such as chromium.

Wheel 2 is of the type which includes a small central opening 5 in the wheel hub 6 and a plurality of exposed lug nut apertures 7 arranged in a circular pattern and spaced for the particular vehicle on which wheel assembly 1 is to be employed. Opening 5 will typically be enclosed by a relatively small cap while the lug nuts themselves (not shown) are exposed once the wheel assembly 1 is mounted to a vehicle.

Wheel cover 3 has a geometry and contour which substantially conform to that of wheel 2, namely, an outer peripheral edge 8 which matingly fits within rim 9 of wheel 2. Spokes 11 extend radially outwardly from the center hub opening 5 which correspond in size, shape and location to the spokes 10 on wheel 2. Between the spokes 11 of wheel cover 3 are decorative openings or windows 12 that are shaped to conform to corresponding decorative openings or windows 13 in wheel 2. The central hub area surrounding central opening 14 of wheel cover 3 also includes a plurality of lug nut receiving openings 15 which align with and are received within openings 7 in wheel 2 when the wheel cover 3 is position on the wheel 2. The central opening 14 of the wheel cover 3 is aligned with opening 5 in wheel hub 6, as best seen in FIG. 1. When the wheel cover 3 is bonded to wheel 2, the wheel cover 3 appears as an integral outer surface of the wheel 1, as depicted in FIG. 1.

The wheel cover 3 is bonded to wheel 2 by an adhesive that securely bonds the wheel cover 3 to the outboard face of the wheel 2. The adhesive can be applied in any desired pattern or as a continuous layer. Alternatively, or in addition, to the use of an adhesive, various known mechanical engaging structures can be used to secure the wheel covers 3 to the wheels 2, including spring biased structures, clips, fasteners, etc.

Although the present invention was primarily developed to advance the fabrication and design of metal wheel covers including stainless steel wheel covers, it has also been determined during the course of the present invention that wheel covers made of solid panels of high-impact plastic materials can have both their outboard and inboard sides plated to dull any sharp edges. An advantage of using a high-impact plastic material such as a combination of polycarbonate and ABS having is that wheel covers 3 made from such materials can be injection molded. However, in certain applications and configurations, plastic wheel covers do not always feel and sound as solid as metal wheel covers.

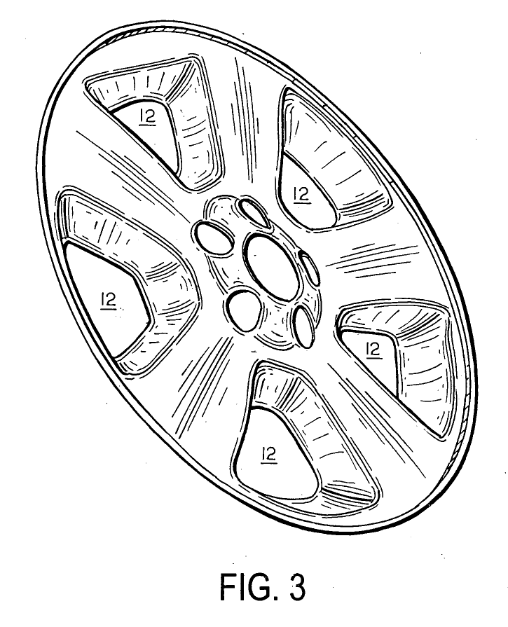

FIG. 3 is a perspective view of a wheel cover design according to one embodiment of the present invention. FIG. 3 depicts one example of a wheel cover design that has a design profile that causes the wheel cover to have shape edges when the stock metal is formed into the design. In particular the design configuration depicted in FIG. 3 includes deep recessed openings or windows 12. When working the stock metal to form the deep openings or windows 12 the metal becomes thin so that at the point where the openings or windows 12 are pierced or punched out, a sharp edge is formed. This sharp edge is dulled according to the present invention by plating both the outboard and inboard sides of the wheel cover with a plating material. It is to be understood that the wheel design configuration depicted in FIG. 3 is only exemplary and that numerous other design configurations can produce free edges that can be dulled by plating both the outboard and inboard sides according to the present invention.

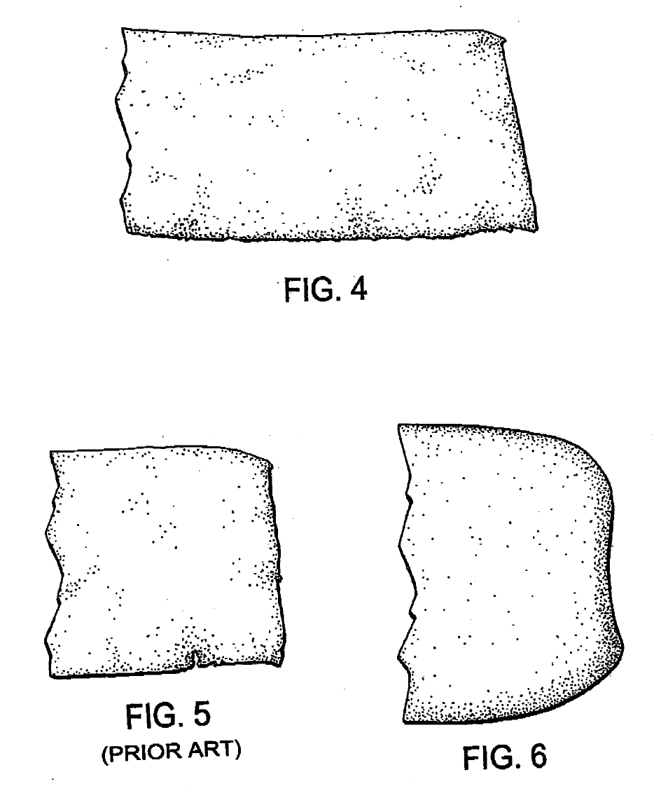

FIGS. 4-6 are presented herein to illustrate the manner in which the method of the present invention can be used to dull sharp edges of a wheel cover. In each of FIGS. 4-6 the wheel covers were formed from 5 mm (0.2 inch) thick stainless steel that was punched out. The metallograph photographs are each of an area of one of the spoke edges of a brake vent window. For each metallograph photograph a portion of the wheel cover was mounted in resin and polished prior to being photographed using a metallograph. The direction of the punching is from the top to the bottom in each figure.

FIG. 4 is a 135× magnified metallograph photo of a cross-sectional portion of a metal wheel cover that has not been plated.

As seen in FIG. 4, sharp edges are formed on each side of the metal wheel cover where the brake vent window has been punched out (right-hand side). Such sharp edges are dulled according to the present invention as disclosed herein.

FIG. 5 is a 135× magnified metallographic photo of a cross-sectional portion of a metal wheel cover that has been plated on one side according to a conventional practice. The wheel cover used to produce FIG. 5 was racked on a plater in a conventional manner used to plate the front, outboard or “A” side of a wheel cover. Typically wheel covers are racked back-to-back on a plater because there is no need to plate the back, inboard or “B” side of the wheel covers. The wheel cover used to produce FIG. 5 was plated with nickel-chrome. The plating was controlled in a conventional manner set to deposit 25 microns of total nickel thickness and 0.25 microns of chromium on the front, outboard or “A” side of a wheel cover.

As can be seen from FIG. 5, the top edge of the sample has become somewhat angled; however, the edges on each side of the metal wheel cover where the brake vent window has been punched out (right-hand side) remain sharp.

FIG. 6 is a 135× magnified metallograph photo of a cross-sectional portion of a metal wheel cover that has been plated on both sides according to one embodiment of the present invention. The wheel cover used to produce FIG. 6 was racked on only one side of a plater so that both sides of the wheel cover would be plated. The wheel cover used to produce FIG. 6 was plated with nickel-chrome. The plating was controlled in a conventional manner set to deposit 25 microns of total nickel thickness and 0.25 microns of chromium on the front, outboard or “A” side of a wheel cover (even though the cover was racked to plate both sides).

As can be seen from FIG. 6, both the top and bottom the edges of the sample (right-hand side) have become rounded out so that there are no sharp edges.

A comparison between FIGS. 4 and 6 and between FIGS. 5 and 6 shows that the two-sided plating process of the present invention dramatically changes the edge structure of the wheel cover while a comparison between FIGS. 4 and 5 show that a one-sided plating process has little effect on dulling the sharp edges.

The edges of the wheel covers produced by the two-sided plating process were rounded sufficiently to eliminate sharp edges.

While the plating processes described above were controlled in a conventional manner set to deposit 25 microns of total nickel thickness and 0.25 microns of chromium on the front, outboard or “A” side of the wheel covers, it was discovered that the thickness of the overall plating was about 1-13 microns along the brake vent window edges in the wheel covers that were only plated on one side. However, it was discovered that plating both sides of the wheel cover to deposit 25 microns of total nickel thickness and 0.25 microns of chromium on the front, outboard or “A” side of the wheel covers, resulting in a overall plating thickness of 60 microns per side at the edges of the brake vent windows. Although not professing to be held to any explanation, this phenomenon is believed to be due in part to magnetic fields that are created in the plating bath during the plating process because of the configuration of the wheel covers.

Although the wheel cover shown in FIG. 6 was plated with nickel-chromium according to a conventional plating process to deposit 25 microns of total nickel thickness and 0.25 microns of chromium, it is within the scope of the present invention to utilize different and any and all conventional plating materials and apply the plating materials at different thickness to dull the shape edges to a desired degree. FIGS. 4-6 are merely presented to demonstrate and compare the effect of plating both sides of a wheel cover with plating only the face, outboard or “A” side of a wheel cover and with a non-plated wheel cover. The thickness of the plating can easily be adjusted to dull the shape edges of any particular decorative wheel cover design to a desired degree.

Although FIGS. 4-6 compare the effects of plating metal wheel covers, the manner of plating both sides of a wheel cover to dull sharp edges according to the present invention is also applicable to plastic wheel covers which are often formed/molded with sharp edges.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as set forth in the following claims.

1. A method of forming a decorative wheel cover that is configured to be attached to a vehicle wheel which method comprises:
forming a wheel cover in a manner that produces at least one sharp free edge along a portion of the wheel cover, the wheel cover including an outboard side and an inboard side; and
subjecting the formed wheel cover to a plating process which plates both the outboard side and inboard side of the wheel cover and dulls the at least one shape free edge.

2. A method of forming a decorative wheel cover according to claim 1, wherein the wheel cover is formed from a metal.

3. A method of forming a decorative wheel cover according to claim 2, wherein the wheel cover is formed from stainless steel.

4. A method of forming a decorative wheel cover according to claim 1, wherein the wheel cover is formed from a plastic material.

5. A method of forming a decorative wheel cover according to claim 1, wherein during the plating process the outboard side and inboard side of the wheel cover are simultaneously plated at the same time.

6. A method of forming a decorative wheel cover according to claim 1, wherein the at least one sharp free edge comprises an edge of an opening formed in the wheel cover.

7. A method of forming a decorative wheel cover according to claim 1, wherein the plating process plates the wheel cover with nickel-chromium.

8. A decorative wheel cover that comprises:
a wheel cover having inboard side, an outboard side and being configured to be attached to a vehicle wheel; and
a metallic plating layer on each of the inboard and outboard sides of the wheel cover.

9. A decorative wheel cover according to claim 8, wherein the wheel cover includes at least one opening formed therein, said at least one opening having an edge which is also plated with the metallic plating layer.

10. A decorative wheel cover according to claim 8, wherein the plating layer on the inboard and outboard sides includes an underlying plating layer and a finish plating layer.

11. A decorative wheel cover according to claim 8, wherein the plating layer on the inboard side is an underlying plating layer and the plating layer on the outboard side includes an underlying plating layer and a finish plating layer.

12. A decorative wheel cover according to claim 8, wherein the wheel cover is made of a metal.

13. A decorative wheel cover according to claim 8, wherein the wheel cover is made of a plastic material.

14. A wheel assembly that comprises:
a wheel having an outboard side; and
a wheel cover attached to the outboard side of the wheel, said wheel cover having inboard side, an outboard side, the inboard and outboard sides of the wheel cover being plated with a metallic material.

15. The wheel assembly according to claim 14, wherein the wheel includes a plurality of openings formed the outboard side and the wheel cover includes a plurality of decorative openings which are aligned with the plurality of openings formed in the wheel and the plurality of decorative openings formed in the wheel cover have edges which are plated with the metallic material.

16. The wheel assembly according to claim 14, wherein the wheel cover is formed from metal.

17. The wheel assembly according to claim 14, wherein the wheel is glued onto the wheel.

18. A method of dulling sharp edges formed on a decorative wheel cover which comprises:
forming a wheel cover in a manner that produces at least one sharp free edge along a portion of the wheel cover, the wheel cover including an outboard side and an inboard side; and
subjecting the formed wheel cover to a plating process which plates both the outboard side and inboard side of the wheel cover and dulls the at least one shape free edge.

19. A method of dulling sharp edges formed on a decorative wheel cover according to claim 18, wherein the at least one sharp free edge comprises an edge of an opening formed in the wheel cover.

20. A method of dulling sharp edges formed on a decorative wheel cover according to claim 18, wherein the wheel cover is formed from a metal.
